(19) United States
(12) Patent Application Publication
(10) Pub. No.: US 2012/0299896 A1
(43) Pub. Date: Nov. 29, 2012

(54) PIXEL STRUCTURE AND DISPLAY SYSTEM UTILIZING THE SAME

(75) Inventors: Du-Zen PENG, Miao-Li County (TW); Tse-Yuan CHEN, Miao-Li County (TW); Chih-Chiang TSENG, Miao-Li County (TW); Shou-Cheng WANG, Miao-Li County (TW); Tsung-Yi SU, Miao-Li County (TW)

(73) Assignees: CHIMEI INNOLUX CORPORATION, Miao-Li County (TW); INNOCOM TECHNOLOGY (SHENZHEN) CO., LTD., Longhua Town (CN)

(21) Appl. No.: 13/477,674

(22) Filed: May 22, 2012

(30) Foreign Application Priority Data
May 26, 2011 (TW) 100118415

(51) Int. Cl. G09G 5/00

(52) U.S. Cl. 345/211

(57) ABSTRACT

A pixel structure including a first switching transistor, a setting unit, a capacitor, a driving transistor, a second switching transistor and a luminous element is disclosed. The capacitor is coupled between a first and a second node. The first switching transistor transmits a data signal to the first node according to a scan signal. The driving transistor includes a threshold voltage and a gate coupled to the second node. The second switching transistor includes a gate receiving an emitting signal. The luminous element is coupled to the driving transistor and the second switching transistor in series between a first operation voltage and a second operation voltage. The setting unit controls the voltage levels of the first and the second nodes to compensate the threshold voltage of the driving transistor.

### CROSS REFERENCE TO RELATED APPLICATIONS

This application claims priority of Taiwan Patent Application No. 100118415, filed on May 26, 2011, the entirety of which is incorporated by reference herein.

### BACKGROUND OF THE INVENTION

1. Field of the Invention

The invention relates to a pixel structure, and more particularly to a pixel structure of a display system.

2. Description of the Related Art

Because cathode ray tubes (CRTs) are inexpensive and provide high definition, they are utilized extensively in televisions and computers. With technological development, new flat-panel displays have continually been developed in recent years. The flat-panel displays are widely used as they possess the favorable advantages of having a thin profile and light weight.

Generally, each flat-panel display comprises a display panel comprising various pixels. Each pixel comprises a driving transistor and a luminous element. The driving transistor generates a driving current according to an image signal. The luminous element displays correspond to brightness according to the driving current.

However, the driving transistors in the different pixels may comprise different threshold voltages because the driving transistors are affected by the manufacturing thereof. When some pixels receive the same image signal, the corresponding driving transistors may generate different driving currents such that corresponding luminous elements display different brightness.

### BRIEF SUMMARY OF THE INVENTION

In accordance with an embodiment, a pixel structure comprises a first switching transistor, a setting unit, a capacitor, a driving transistor, a second switching transistor and a luminous element. The first switching transistor transmits a data signal to a first node according to a scan signal. The setting unit controls the voltage level of the first node and the voltage level of a second node according to the scan signal and a discharging signal. The capacitor is coupled between the first and the second nodes. The driving transistor comprises a first threshold voltage and a gate coupled to the second node. The second switching transistor comprises a gate receiving an emitting signal. The luminous element is coupled to the driving transistor and the second switching transistor in series between a first operation voltage and a second operation voltage. During a first period, the setting unit controls the voltage level of the first node to equal to a first reference voltage and controls the voltage level of the second node to equal to a second reference voltage, and the first reference voltage exceeds the second reference voltage. During a second period, the first switching transistor transmits the first data signal to the first node, and the setting unit controls the voltage level of the second node to equal to a difference between the first operation voltage and the first threshold voltage. During a third period, the setting unit controls the voltage level of the first node to equal to the first reference voltage and floats the second node.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1 is a schematic diagram of an exemplary embodiment of a display system;

FIGS. 2A, 3 and 4 are schematic diagrams of other exemplary embodiments of a pixel structure; and

FIG. 2B is a timing diagram of an exemplary embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

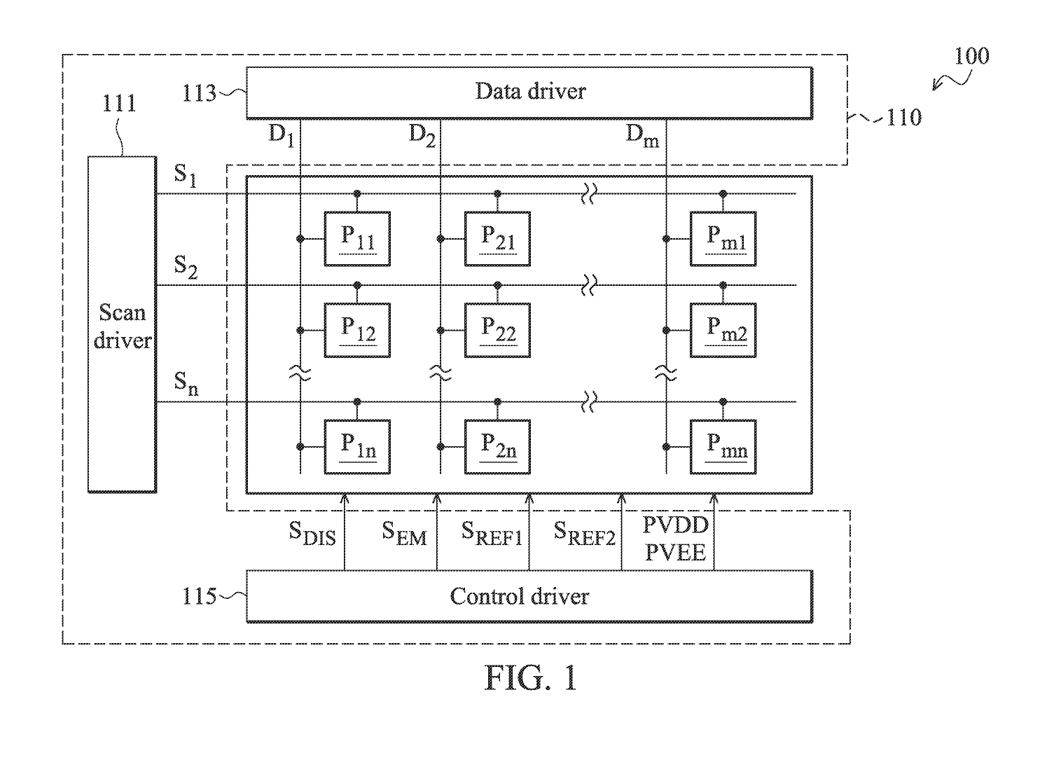

FIG. 1 is a schematic diagram of an exemplary embodiment of a display system. The display system 100 comprises a driving module 110 and pixels P₁₁˜Pₘₙ. The driving module 110 provides signals to the pixels P₁₁˜Pₘₙ. In this embodiment, the driving module 110 comprises a scan driver 111, a data driver 113 and a control driver 115.

The scan driver 111 provides scan signals S₁˜Sₙ to the pixels P₁₁˜Pₘₙ. The data driver 113 provides data signals D₁˜Dₘ to the pixels P₁₁˜Pₘₙ. The pixels P₁₁˜Pₘₙ receive the data signals D₁˜Dₘ according to the scan signals S₁˜Sₙ and display corresponding brightness according to the data signals D₁˜Dₘ. The control driver 115 provides a discharging signal S_{DIS}, an emitting signal S_{EM}, reference voltages S_{REF1}, S_{REF2}, and operation voltages PVDD and PVEE to the pixels P₁₁˜Pₘₙ such that driving transistors of the pixels P₁₁˜Pₘₙ generate driving currents and each driving current is not affected by the threshold voltage of the corresponding driving transistor.

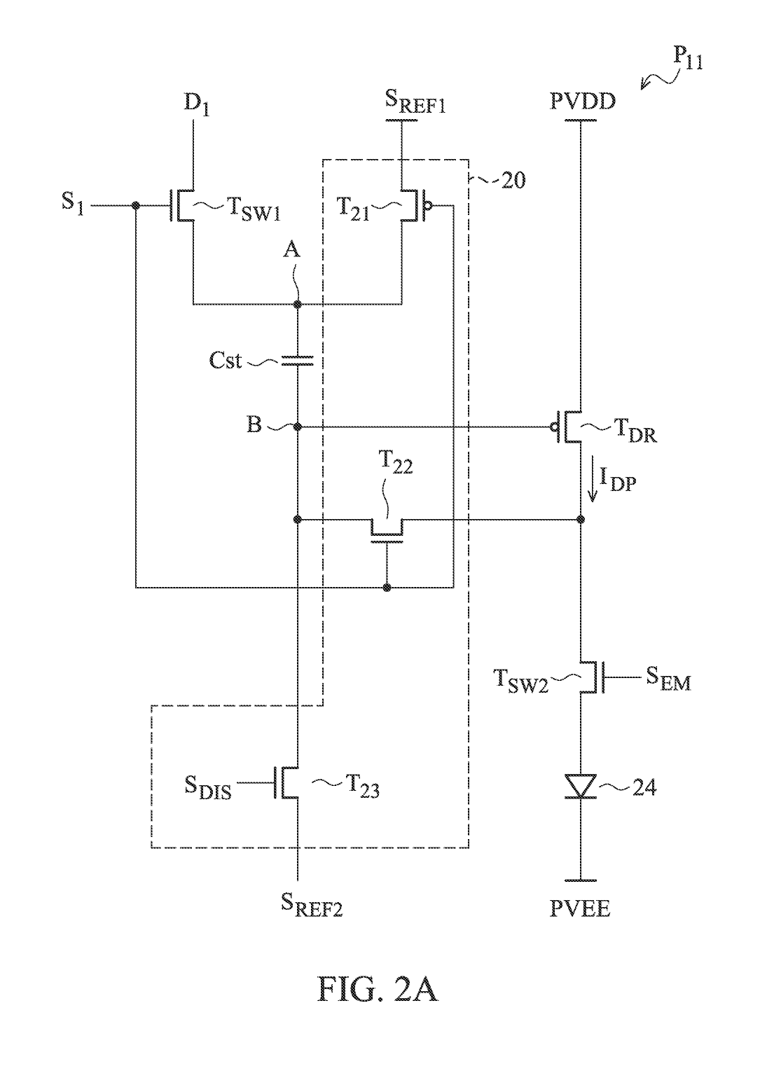

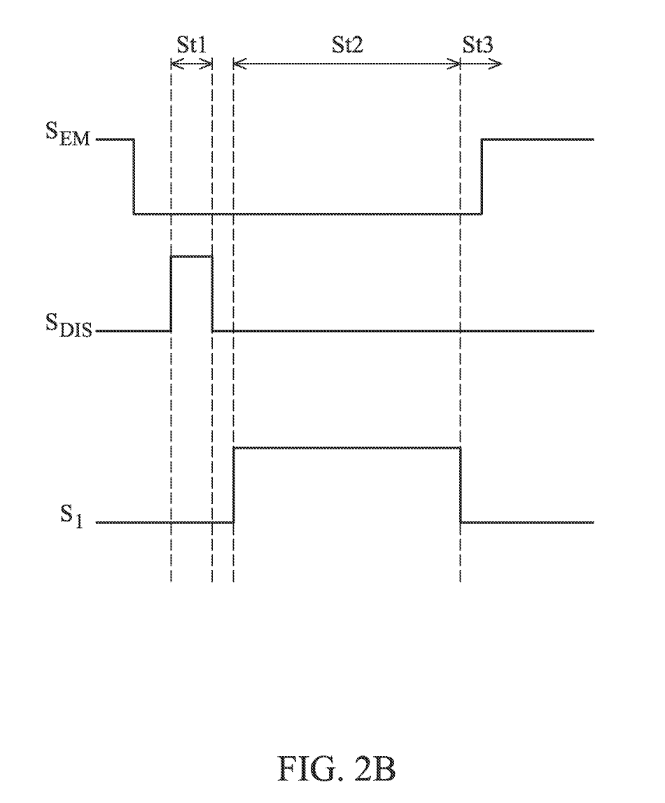

FIG. 2A is a schematic diagram of an exemplary embodiment of a pixel structure. Since the circuits of the pixels P₁₁˜Pₘₙ are the same, the pixel P₁₁ is given as an example. As shown in FIG. 2A, the pixel P₁₁ comprises switching transistors T_{SW1}, T_{SW2}, a setting unit 20, a capacitor Cst, a driving transistor T_{DR} and a luminous element 24.

The switching transistor T_{SW1} transmits the data signal D₁ to a node A according to the scan signal S₁. The invention does not limit the type of the switching transistor T_{SW1}. In this embodiment, the switching transistor T_{SW1} is an N-type transistor. The N-type transistor comprises a gate receiving the scan signal S₁, a drain receiving the data signal D₁ and a source coupled to the node A.

The capacitor Cst is coupled between the nodes A and B. The driving transistor T_{DR} comprises a threshold voltage (Vt_{(DR)}). The invention does not limit the type of the driving transistor T_{DR}. In this embodiment, the driving transistor T_{DR} is a P-type transistor. The P-type transistor comprises a gate coupled to the node B, a source receiving the operation voltage PVDD and a drain coupled to the setting unit 20 and the switching transistor T_{SW2}.

The switching transistor T_{SW2} transmits a driving current I_{DP} generated by the driving transistor T_{DR} to the luminous element 24 according to the emitting signal S_{EM}. The invention does not limit the type of the switching transistor T_{SW2}. In this embodiment, the switching transistor T_{SW2} is an N-type transistor. The N-type transistor comprises a gate receiving the emitting signal S_{EM}, a drain coupled to the driving transistor T_{DR} and a source coupled to the luminous element 24.

The luminous element 24 is coupled to the driving transistor T_{DR} and the switching transistor T_{SW2} in series between the operation voltages PVDD and PVEE. The invention does not limit the kind of the luminous element 24. Any element, which is lighted according to a driving current, can serve as the luminous element 24. In one embodiment, the luminous element 24 is an organic light emitted diode (OLED).

The setting unit 20 and the switching transistor T_{SW1} controls the voltage levels of the nodes A and B according to the scan signal S₁ and the discharging signal S_{DIS}. The invention does not limit the circuit of the setting unit 20. Any circuit, which can achieve the setting functions of the setting unit 20, can serve as the setting unit 20.

During a first period, the setting unit 20 controls the voltage level of the node A to equal to the reference voltage S_{REF1} and controls the voltage level of the node B to equal to the reference voltage S_{REF2}. The reference voltage S_{REF1} is different from the reference voltage S_{REF2}. In this embodiment, the reference voltage S_{REF1} exceeds the reference voltage S_{REF2}. In another embodiment, the reference voltage S_{REF1} is a positive value and the reference voltage S_{REF2} is a negative value. In other embodiments, a difference between the reference voltages S_{REF1} and S_{REF2} exceeds the threshold voltage of the driving transistor T_{DR}.

During a second period, the switching transistor T_{SW1} transmits the data signal D₁ to the node A. During this period, the setting unit 20 controls the voltage level of the node B to equal to a difference between the operation voltage PVDD and the threshold voltage Vt_{(DR)} of the driving transistor T_{DR}.

Since the voltage level of the node A is different from the voltage level of the node B during the first period, when the voltage level of the node A is equal to the data signal D₁ during the second period, the voltage level of the node B is equal to the difference between the operation voltage PVDD and the threshold voltage Vt_{(DR)} of the driving transistor T_{DR} during the second period.

During a third period, the setting unit 20 controls the nodes A and B such that the voltage level of the node A is equal to the reference voltage S_{REF1} and the node B is in a floating state. At this period, the voltage level V_{B} of the node B is equal to PVDD-Vt_{(DR)}−(D₁-S_{REF1}).

During the third period, the driving transistor T_{DR} generates the driving current I_{DP} according to the following equation (1):

I_{DP}=K_{P}*(Vsg−Vt_{(DR)})² Equation (1).

wherein K_{P} is a parameter of the driving transistor T_{DR} and is a pre-determined value, Vsg is a difference between the source of the driving transistor T_{DR} and the gate of the driving transistor T_{DR}, and Vt_{(DR)} is the threshold voltage of the driving transistor T_{DR}.

If we substitute the difference between the source and the gate of the driving transistor T_{DR} with equation (1), the substituted result is expressed by the following equation (2):

I_{DP}=K_{P}*{PVDD−[PVDD−Vt_{(DR)}−(D₁−S_{REF1})]−Vt_{(DR)}}² Equation (2).

If we simplify equation (2):

I_{DP}=K_{P}*(D₁−S_{REF1})² Equation (3).

According to the equation (3), the driving current I_{DP} is not affected by the threshold voltage Vt_{(DR)} of the driving transistor T_{DR}. Thus, if the driving transistors of some pixels comprise the different threshold voltages and the some pixels receive the same data signals, the driving transistors of the some pixels generate the same driving currents.

The invention does not limit the circuit structure of the setting unit 20. Any circuit, which can achieve the above functions, can serve as the setting unit 20. In this embodiment, the setting unit 20 comprises setting transistors T₂₁˜T₂₃.

The setting transistor T₂₁ transmits the reference voltage S_{REF1} to the node A according to the scan signal S₁. The setting transistor T₂₂ controls the driving transistor T_{DR} such that the gate of the driving transistor T_{DR} is connected to the drain of the driving transistor T_{DR}. Thus, the driving transistor T_{DR} forms a diode connection. The setting transistor T₂₃ transmits the reference voltage S_{REF2} to the node B according to the discharging signal S_{DIS}.

The invention does not limit the type of the setting transistors T₂₁˜T₂₃. In this embodiment, the setting transistor T₂₁ is a P-type transistor and the setting transistors T₂₂ and T₂₃ are N-type transistors, however, the invention is not limited thereto. In other embodiments, the setting transistors T₂₁˜T₂₃ are P-type transistors or are N-type transistors or a portion of the setting transistors T₂₁˜T₂₃ are N-type transistors or P-type transistors. The method for transformation between P-type and N-type transistors is well known to those skilled in the field, thus, description thereof is omitted for brevity. FIG. 2A is given as an example to describe the connection of the setting transistors T₂₁˜T₂₃.

As shown in FIG. 2A, the setting transistor T₂₁ comprises a gate receiving the scan signal S₁, a source receiving the reference voltage S_{REF1} and a drain coupled to the node A. The setting transistor T₂₂ comprises a gate receiving the scan signal S₁, a drain coupled to the node B and a source coupled to the drain of the driving transistor T_{DR}. The setting transistor T₂₃ comprises a gate receiving the discharging signal S_{DIS}, a drain receiving the reference voltage S_{REF2} and a source coupled to the node B.

FIG. 2B is a timing diagram of an exemplary embodiment of the invention. During the first period St1, the scan signal S₁ is at a low level to turn on the setting transistor T₂₁. Thus, the voltage level of the node A is equal to the reference voltage S_{REF1}. At this period, the discharging signal S_{DIS} is at a high level such that the setting transistor T₂₃ is turned on. Thus, the voltage level of the node B is equal to the reference voltage S_{REF2}.

During the second period St2, the scan signal S₁ is at the high level to turn on the switching transistor T_{SW1} and the setting transistor T₂₂. Thus, the voltage level of the node A is equal to the data signal D₁, and the gate of the driving transistor T_{DR} is connected to the drain of the driving transistor T_{DR}. Since the driving transistor T_{DR} forms a diode connection, the voltage level of the node B is the difference between the operation voltage PVDD and the threshold voltage Vt_{(DR)} of the driving transistor T_{DR}.

During the third period St3, the scan signal S₁ is at the low level to again turn on the setting transistor T₂₁. Thus, the voltage level of the node A is equal to the reference voltage S_{REF1}. Since the scan signal is at the low level, the setting transistors T₂₂ and T₂₃ are turned off. In this embodiment, the voltage level of the node B is equal to PVDD−Vt_{(DR)}−(D₁−S_{REF1}). When the emitting signal S_{EM} is at the high level, the switching transistor T_{SW2} is turned on to transmit the driving current I_{DP} to the luminous element 24. The driving current I_{DP} is expressed by the equation (3).

During the first period St1, the voltage level of the node B is less than the voltage level of the node A. Thus, when the voltage level of the node A is equal to the data signal D₁ (during the second period St2), the driving transistor T_{DR} and the setting transistor T₂₂ normally operates due to the coupling effect of the capacitor Cst. In other words, the voltage level of the node B is equal to PVDD−Vt_{(DR)}. Thus, the driving transistor T_{DR} forms a diode connection. In addition, the gray level of the data signal D₁ can equal to the operation voltage PVDD. Since the maximum gray level of the data signal is not limited in PVDD−Vt_{(DR)}, the range of the gray level is increased. In other words, when the operation voltage PVDD is reduced, the power consumption can be reduced and the range of the gray level is not affected.

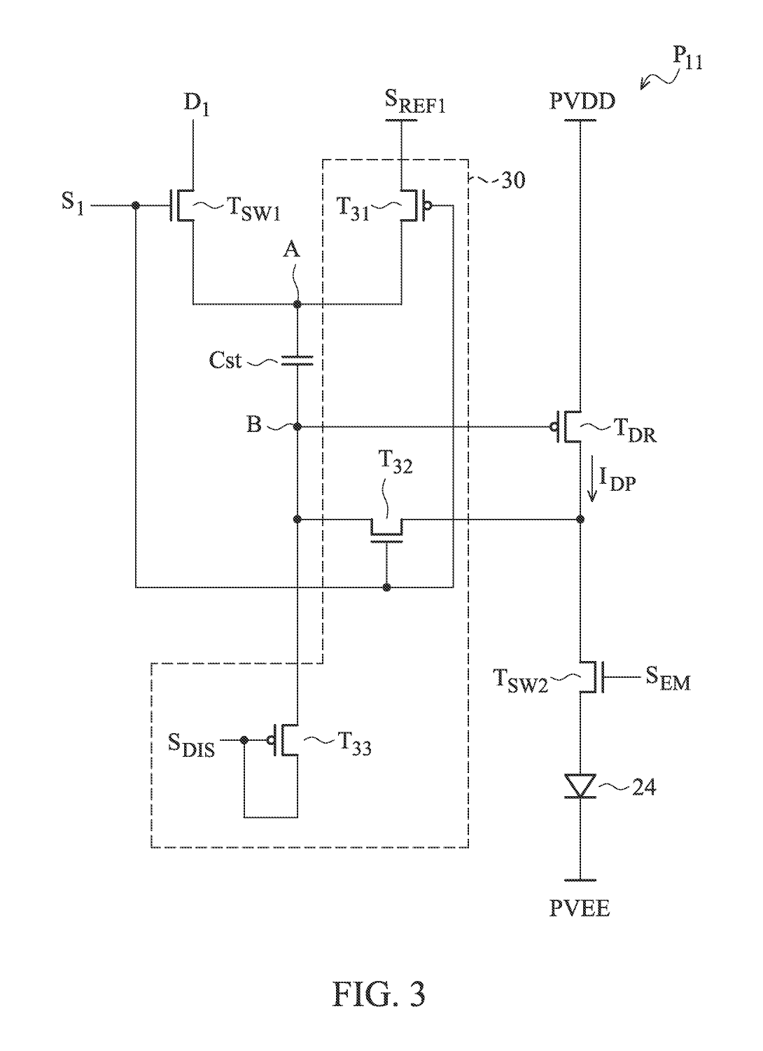

FIG. 3 is a schematic diagram of another exemplary embodiment of the pixel structure. FIG. 3 is similar to FIG. 2A with the exception that the setting transistor T₃₃ is a P-type transistor. Since the connection between the setting transistors T₃₁ and T₃₂ is the same as the connection between the setting transistors T₂₁ and T₂₂, description is omitted for brevity.

In this embodiment, the setting transistor T₃₃ is a diode connection. The setting transistor T₃₃ comprises a gate receiving the discharging signal Sₘₛ, a drain coupled to the node B and a source receiving the discharging signal S_{DIS}. When the discharging signal S_{DIS} is at the low level, the voltage level of the node B is equal to the sum of the operation voltage PVEE and the threshold voltage of the setting transistor T₃₃. In one embodiment, the discharging signal S_{DIS} is equal to the operation voltage PVEE.

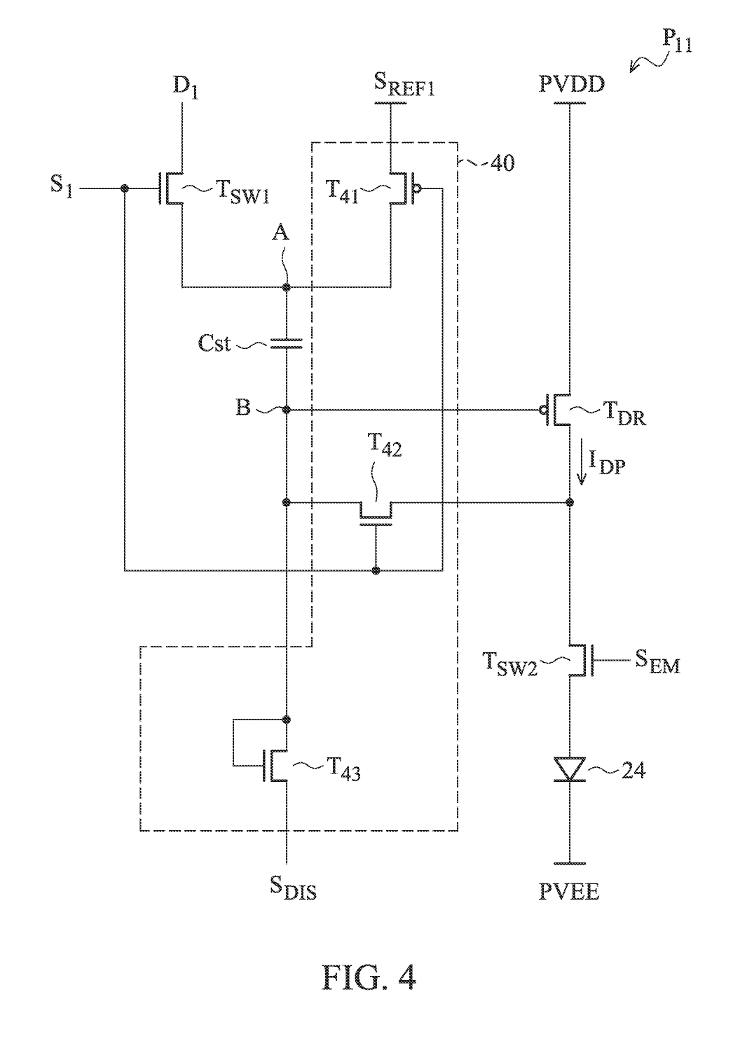

FIG. 4 is a schematic diagram of another exemplary embodiment of the pixel structure. FIG. 4 is similar to FIG. 2A with the exception that the setting transistor T₄₃ is an N-type transistor. Since the connection between the setting transistors T₄₁ and T₄₂ is the same as the connection between the setting transistors T₂₁ and T₂₂, description is omitted for brevity.

In this embodiment, the setting transistor T₄₃ is a diode connection. The setting transistor T₄₃ comprises a gate coupled to the node B, a drain receiving the discharging signal S_{DIS} and a source coupled to the node B. When the discharging signal S_{DIS} and the voltage level of the node B are sufficient to turn on the setting transistor T₄₃, the voltage level of the node B is equal to the sum of the operation voltage PVEE and the threshold voltage of the setting transistor T₄₃. In one embodiment, the discharging signal S_{DIS} is equal to the operation voltage PVEE.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A pixel structure, comprising:
a first switching transistor transmitting a data signal to a first node according to a scan signal;
a setting unit controlling the voltage level of the first node and the voltage level of a second node according to the scan signal and a discharging signal;
a capacitor coupled between the first and the second nodes;
a driving transistor comprising a first threshold voltage and a gate coupled to the second node;
a second switching transistor comprising a gate receiving a emitting signal; and
a luminous element coupled to the driving transistor and the second switching transistor in series between a first operation voltage and a second operation voltage,
wherein during a first period, the setting unit controls the voltage level of the first node to equal to a first reference voltage and controls the voltage level of the second node to equal to a second reference voltage, and the first reference voltage exceeds the second reference voltage,
wherein during a second period, the first switching transistor transmits the first data signal to the first node, and the setting unit controls the voltage level of the second node to equal to a difference between the first operation voltage and the first threshold voltage, and
wherein during a third period, the setting unit controls the voltage level of the first node to equal to the first reference voltage and floats the second node.

2. The pixel structure as claimed in claim 1, wherein a difference between the first and the second reference voltages exceeds the first threshold voltage.

3. The pixel structure as claimed in claim 1, wherein the first reference voltage is a positive value and the second reference voltage is an negative value.

4. The pixel structure as claimed in claim 1, wherein the setting unit comprises:
a first setting transistor transmitting the first reference voltage to the first node according to the scan signal;
a second setting transistor making the gate of the driving transistor connected to the drain of the driving transistor; and
a third setting transistor transmitting the second reference voltage to the second node according to the discharging signal, wherein the second reference voltage is equal to the second operation voltage.

5. The pixel structure as claimed in claim 4, wherein the third setting transistor is a N-type transistor comprising a gate receiving the discharging signal, a drain receiving the second operation voltage and a source coupled to the second node.

6. The pixel structure as claimed in claim 1, wherein the setting unit comprises:
a first setting transistor transmitting the first reference voltage to the first node according to the scan signal;
a second setting transistor making the gate of the driving transistor connected to the drain of the driving transistor; and
a third setting transistor comprising a second threshold voltage, wherein during the second period, the third setting transistor controls the second reference voltage to equal to the sum of the second operation voltage and the second threshold voltage.

7. The pixel structure as claimed in claim 6, wherein the third setting transistor is a P-type transistor comprising a gate receiving the discharging signal, a source coupled to the gate of the P-type transistor and a drain coupled to the second node.

8. The pixel structure as claimed in claim 7, wherein the discharging signal is equal to the second operation voltage.

9. The pixel structure as claimed in claim 6, wherein the third setting transistor is an N-type transistor comprising a gate, a source coupled to the gate of the N-type transistor and a drain receiving the discharging signal.

10. The pixel structure as claimed in claim 9, wherein the discharging signal is equal to the second operation voltage.

11. A display system comprising:
a pixel structure as claimed in claim 1; and
a driving module providing the scan signal, the data signal, the first and the second reference voltages, the discharging signal, the emitting signal and the first and the second operation voltages.
